(19) United States
(12) Patent Application Publication
(10) Pub. No.: US 2024/0427762 A1
(43) Pub. Date: Dec. 26, 2024

(54) METHOD FOR GENERATING SYNTHETIC DATA AND A COMPUTING DEVICE ON WHICH THE METHOD IS IMPLEMENTED

(71) Applicant: Pebblous Inc., Daejeon (KR)

(72) Inventors: Joo Haeng Lee, Sejong-si (KR); Jeong Won Lee, Daejeon (KR)

(21) Appl. No.: 18/745,954

(22) Filed: Jun. 17, 2024

(30) Foreign Application Priority Data
Jun. 22, 2023 (KR) 10-2023-0080079
Feb. 26, 2024 (KR) 10-2024-0026906
Feb. 26, 2024 (KR) 10-2024-0026907
Feb. 26, 2024 (KR) 10-2024-0026908
Feb. 26, 2024 (KR) 10-2024-0026909

(51) Int. Cl. G06F 16/2452; G06F 16/2458

(52) U.S. Cl. CPC G06F 16/24522; G06F 16/2458

(57) ABSTRACT

A device, for generating synthetic data, configured to: receive a first input query requesting data generation; determine a constraint related to synthetic data based on the first input query; obtain a first structured query processed in a predetermined manner suitable for a database based on the constraint; provide the first structured query to the database to obtain imported data; obtain a second structured query processed in a predetermined manner suitable for a generative model based on the constraint; provide the second structured query to the generative model; obtain synthetic data from the generative model; determine similarity between the imported data and the synthetic data by calculating a distance in embedding space between an embedded feature of the imported data and an embedded feature of synthetic data; and provide output data comprising the imported data, the synthetic data, and similarity information.

### CROSS-REFERENCE TO RELATED APPLICATION

This U.S. application claims priority to and the benefit of Korean Patent Application No. 2023-0080079, filed on Jun. 22, 2023, Korean Patent Application No. 2024-0026906, filed on Feb. 26, 2024, Korean Patent Application No. 2024-0026907, filed on Feb. 26, 2024, Korean Patent Application No. 2024-0026908, filed on Feb. 26, 2024, and Korean Patent Application No. 2024-0026909, filed on Feb. 26, 2024, in the Korean Intellectual Property Office (KIPO), the disclosures of all of which are incorporated by reference herein in their entireties.

### BACKGROUND

### 1. Technical Field

The present disclosure relates to a computing device for processing data, and particularly to a computing device for generating or evaluating data, and for training or evaluating an artificial intelligence model.

### 2. Discussion of the Related Art

Recently, artificial intelligence algorithms based on deep learning have been utilized in most technical fields. Particularly, the use of unstructured data, which lacks regularity, has become prominent in the deep learning applications. Consequently, the challenge of managing the quantity of data required for training has arisen.

To address this challenge, the industry has proposed various solutions. One significant advancement is the technology for generating synthetic data, which is now used to train deep learning models across various technical domains.

Additionally, the development of diverse generative models has led to the creation of numerous services using generative models. Notably, the advancement of Large Language Models (LLMs) based on transformer architectures is progressing rapidly.

Therefore, there is a need to develop technology for generating synthetic data using generative models.

### SUMMARY

One objective of the present disclosure is to generate synthetic data corresponding to a user's intent based on a query. Another objective is to evaluate the quality of synthetic data. Furthermore, the present disclosure aims to evaluate the performance of an artificial intelligence model using synthetic data, train an artificial intelligence model with synthetic data, and provide a user interface for processing synthetic data.

The objectives of the present disclosure are not limited to the aforementioned objectives. Other tasks not mentioned may be apparent to those skilled in the art from the specification and the accompanying drawings.

According to one embodiment of the present disclosure, a computing device may comprise a memory including at least one database and at least one processor electronically connected to the memory. The processor is configured to receive a first input query requesting data generation; determine at least one constraint related to synthetic data based on the first input query; obtain a first structured query processed in a predetermined manner suitable for a database based on the at least one constraint; provide the first structured query to the database to obtain imported data by searching the database for data corresponding to the at least one constraint; obtain a second structured query processed in a predetermined manner suitable for a generative model based on the at least one constraint; provide the second structured query to the generative model; obtain synthetic data from the generative model; determine similarity between the imported data and synthetic data by calculating a distance in embedding space between an embedded feature of the imported data and an embedded feature of synthetic; and provide output data comprising the imported data, the synthetic data, and similarity information reflecting the similarity between the imported data and the synthetic data. The query structure of the first structured query differs from that of the second structured query.

According to another embodiment of the present disclosure, a method of processing data in a computing device may comprise receiving a first input query requesting data generation; obtaining prompt data based on the first input query and inputting the prompt data to a generative model; obtaining synthetic data from at least one layer of the generative model; generating a structured query processed in a predetermined manner suitable for a pre-stored model source based on the first input query; obtaining a first artificial intelligence model based on the structured query and the model source; and obtaining result data by inputting the synthetic data to the first artificial intelligence model. The result data represents an evaluation result of the synthetic data or the first artificial intelligence model.

According to another embodiment of the present disclosure, a computing device may comprise a memory storing a plurality of instructions and at least one processor electronically connected to the memory. The processor is configured to provide prompts for data generation obtained based on user input and first data to a generative model, wherein the first data is included in a first training data set; obtain synthetic data from at least one layer in the generative model, wherein the synthetic data includes second data with at least one adjusted characteristic of the first data; store the synthetic data in a database to build a second training data set including the synthetic data and the first data; and train a target model based on the second training data set.

According to another embodiment of the present disclosure, a method of processing data based on user interaction may comprise receiving a prompt input from a client device; obtaining synthetic data from at least one layer of the generative model by providing the prompt to the generative model; and providing output data to the client device, wherein the output data comprises a first user interface for inputting the synthetic data to a pre-stored auxiliary network and a second user interface including a first attribute object corresponding to at least one attribute value of the synthetic data.

According to the present disclosure, a computing device for generating synthetic data corresponding to a user's intent based on a query may be provided. Furthermore, a computing device for implementing an automated pipeline for training and evaluating an artificial intelligence model may be provided.

The embodiments and effects of the present disclosure are not limited to those mentioned above. A better understanding of various embodiments and effects of the present disclosure may be gained by those skilled in the art with reference to the following detailed description and the accompanying drawings.

### BRIEF DESCRIPTION OF THE DRAWINGS

FIG. 1 is a diagram illustrating an example of a data processing system according to various embodiments.

FIG. 2 is a diagram illustrating a configuration of a computing device included in the example system (1) of FIG. 1 according to various embodiments.

FIG. 3 is a diagram illustrating modules in which various data processing methods are implemented by a computing device according to various embodiments.

FIGS. 4A and 4B are diagrams illustrating examples of processing data using at least one module included in a computing device according to various embodiments.

FIG. 5 is a flowchart illustrating an embodiment in which a computing device generates data according to various embodiments.

FIG. 6 is a diagram illustrating an example of a framework in which a computing device generates data according to various embodiments.

FIGS. 7 and 8 are diagrams illustrating a user interaction method for output data according to various embodiments.

FIG. 9 is a flowchart illustrating another embodiment in which a computing device generates data according to various embodiments.

FIG. 10 is a diagram illustrating a method in which a computing device provides similarity information between data according to various embodiments.

FIG. 11 is a flowchart illustrating an evaluation method using synthetic data according to various embodiments.

FIG. 12 is a diagram illustrating an example of a framework providing an evaluation method using synthetic data according to various embodiments.

FIG. 13 is a flowchart illustrating a method in which a computing device evaluates synthetic data according to various embodiments.

FIG. 14 is a diagram illustrating an example of a framework in which a computing device evaluates synthetic data according to various embodiments.

FIG. 15 is a diagram illustrating configurations for a computing device to build a training data set and train an artificial intelligence model according to various embodiments.

FIG. 16 is a flowchart illustrating a method in which a computing device trains an artificial intelligence model using verified synthetic data according to various embodiments.

FIG. 17 is a flowchart illustrating a method in which a computing device trains an artificial intelligence model according to various embodiments.

FIG. 18 is a diagram illustrating an example of a framework in which a computing device trains an artificial intelligence model according to various embodiments.

FIG. 19 is a flowchart illustrating a method in which a computing device tunes a pre-training model according to various embodiments.

FIG. 20 is a diagram illustrating an example of a framework in which a computing device tunes a pre-training model according to various embodiments.

FIG. 21 is a flowchart illustrating a method in which a computing device provides a user interaction function for synthetic data according to various embodiments.

FIG. 22 is a diagram illustrating an example of a plurality of user interaction functions provided by a computing device according to various embodiments.

FIGS. 23, 24, and 25 are diagrams illustrating an example of user interaction provided by a computing device according to various embodiments.

FIGS. 26, 27, 28, and 29 are diagrams illustrating examples of providing a user interface for processing synthetic data by a computing device according to various embodiments.

### DETAILED DESCRIPTION OF THE EMBODIMENTS

Hereinafter, the embodiments of the present disclosure will be described in detail with reference to the accompanying drawings. In describing the embodiments, well-known technical contents that are relevant to the present disclosure will be omitted to clearly convey the subject matter of the present disclosure.

The embodiments described in this specification are intended to clearly describe the spirit of the present invention to those of ordinary skill in the art. The present invention is not limited to the embodiments described herein, and the scope of the present invention should be interpreted to include modifications or variations that do not depart from its spirit. The example embodiments provided herein are for explaining the principles of the invention and its various applications, thereby enabling those skilled in the art to utilize the invention and understand the embodiments with many modifications and variations.

Although the terms used in this specification have been selected as general terms currently widely used considering the functions of the present invention, they may vary depending on the intention of those skilled in the art, precedents, or the appearance of new technologies. However, when a specific term is defined and used with different meanings, the specific meaning will be separately described. Therefore, terms used in this specification should be interpreted based on their substantive meaning and the overall context of this specification rather than their mere literal meaning.

The accompanying drawings are intended to easily describe the present invention, and the shapes illustrated in the drawings may be exaggerated as necessary to aid understanding of the present invention. Thus, the present invention is not limited by the drawings.

When it is determined that detailed descriptions of known configurations or functions related to the present invention may obscure the subject matter, such descriptions will be omitted as necessary. Additionally, the numbers (e.g., first and second) used in the descriptions are merely identifying symbols for differentiating one component from another and do not imply a sequential or hierarchical order unless the context clearly indicates otherwise. Throughout the specification, the same reference numbers refer to the same components.

The suffixes “part,” “module,” and “unit” used for components in the specification are provided for ease of drafting and do not imply distinct meanings, functions, or roles by themselves. The terms “first” and “second” may be used to describe various components, but these terms are only for differentiation purposes. For example, the first component may be termed the second component, and vice versa.

As used in the embodiments and claims, the singular forms “a,” “an,” and “the” include plural forms as well, unless the context clearly indicates otherwise. It is also understood that the symbols “/” and “and/or” refer to and encompass any and all possible combinations of the associated listed items.

It should be understood that when a component is referred to as being “connected” or “coupled” to another component, it may be directly connected or coupled, but other components may be present in between. Conversely, when a component is referred to as being “directly connected” or “directly coupled” to another component, it should be understood that there are no intervening components. Other expressions describing the relationship between components (i.e., “between” and “immediately between” or “neighboring to” and “directly neighboring to”) should be interpreted similarly.

In the drawings, each block in the processing flowchart and combinations of the flowcharts may be performed by computer program instructions. These instructions may be embedded on a processor of a general-purpose computer, special-purpose computer, or other programmable data processing apparatus. The instructions executed through the processor create means for performing the functions described in the blocks of the flowchart. These instructions may be stored in a computer-usable or computer-readable memory to direct a computer or other programmable data processing apparatus to implement a function in a specific manner, producing an article of manufacture containing instruction means for performing the functions described. Additionally, the instructions may be embedded in a computer or other programmable data processing apparatus and may provide steps for executing the functions described by generating a computer-executed process through a series of operational steps.

Each block may represent a module, segment, or portion of code including one or more executable instructions for performing a specified logical function(s). It should be noted that in some embodiments, the functions mentioned in the blocks may occur in a different order than described. For example, two blocks shown in succession may be performed substantially simultaneously or in reverse order, depending on the corresponding functions.

The term “unit” used in this disclosure refers to software or hardware components such as Field Programmable Gate Array (FPGA) or Application Specific Integrated Circuit (ASIC). The “unit” performs specific roles but is not limited to software or hardware. The “unit” may be configured to be in an addressable storage medium or to reproduce one or more processors. Accordingly, in some embodiments, the “unit” includes components such as software components, object-oriented software components, class components, processes, functions, attributes, procedures, subroutines, segments of program code, drivers, firmware, microcode, circuits, data, databases, data structures, tables, arrays, and variables. The functions provided in the components and “units” may be combined into fewer components and “units,” or it may be separated into additional components and “units.” The components and “units” may be implemented to reproduce one or more CPUs in a device or a secure multimedia card. Additionally, according to various embodiments of the present disclosure, the “units” may include one or more processors.

Hereinafter, the operating principles of the present disclosure will be described in detail with reference to the accompanying drawings. When describing the present disclosure, detailed descriptions of related known functions or configurations will be omitted if it is determined that they may obscure the subject matter. The terms described below are defined considering the functions of the present disclosure and may vary depending on the user, operator, or custom. Therefore, definitions should be given based on the description throughout this specification.

### [Data Processing System]

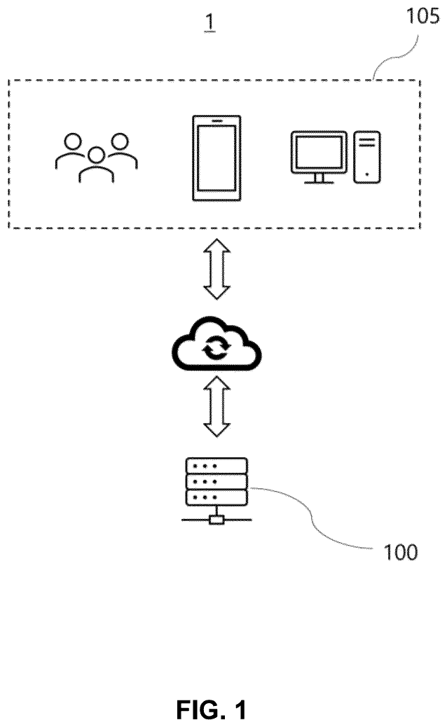

FIG. 1 is a diagram illustrating an example of a data processing system according to various embodiments. Here, the system may refer to a system including at least one software configuration or a hardware configuration to perform a specific function.

Referring to FIG. 1, the data processing system (1) may include a plurality of apparatuses for transmitting, receiving, and processing data according to various embodiments of the present disclosure.

Specifically, the system (1) may include a computing device 100 providing a data processing solution and a plurality of client devices 105 communicatively connected to the computing device to receive the data processing solution.

The client device 105 may transmit a request for data processing to the computing device 100, and the computing device may perform data processing in response to the request and then provide the result to the client device 105. For example, the client device 105 may transmit a request for generating data to the computing device 100, and the computing device may generate data corresponding to the request and provide the data to the client device 105.

The computing device 100 included in the data processing system (1) may provide various methods of data processing solutions according to various embodiments of the present disclosure.

The computing device 100 may generate synthetic data using a generative model. Additionally, the computing device 100 may evaluate the quality of the generated synthetic data, evaluate the performance of the artificial intelligence model using the generated synthetic data, train the artificial intelligence model by building training data based on the generated synthetic data, or additionally train the pre-trained artificial intelligence model. Furthermore, the computing device 100 may provide a user interface for data processing to the client device and may offer data processing interactions based on user input provided through the user interface.

According to the present disclosure, the computing device may provide a data processing service based on various artificial intelligence frameworks executed by at least one processor and a memory electronically connected to the at least one processor.

Various types of artificial intelligence frameworks can train the computing device to perform a given task. Examples of artificial intelligence frameworks include support vector machines, decision trees, and neural networks, which are used in various applications such as image processing and natural language processing. Some machine learning frameworks, such as neural networks, use layers of nodes that perform specific operations.

In neural networks, nodes are connected through one or more edges. The neural network may include an input layer, an output layer, and one or more intermediate layers. Each node processes an input according to a predefined function and provides output to a subsequent layer or, in some cases, to a previous layer. The input for a specific node may be multiplied by a weight value corresponding to the edge between the input and the node. Additionally, the node may have an individual bias value used to generate the output. Various training procedures may be applied to train the edge weights and/or bias values (parameters).

The neural network structure may have several layers that perform different specific functions. For example, one or more node layers may collectively perform specific operations such as pooling, encoding, or convolutional operations. In the present disclosure, the term “layer” may refer to a group of nodes that share input and output, such as exchanging with other layers of an external source or network. The term “calculation” may refer to a function that can be performed in one or more node layers. The term “model structure” may refer to the overall architecture of a layered model, including the number of layers, the connectivity of the layers, and the types of tasks performed by individual layers. The term “neural network structure” may refer to the model structure of a neural network. The term “training model” and/or “tuning model” may refer to a model structure along with parameters for training or tuning a model structure. For example, two trained models may have different parameter values while sharing the same model structure if they are trained on different training data or if there is a fundamental probabilistic process in the training process.

“Transfer learning” is an approach to training a model with training data for each task that is limited to a specific task. In transfer learning, the model may first be pre-trained with respect to other tasks that can use important training data, and then the model may be adjusted to suit a specific task using task-specific training data.

The term “pre-training” used in the present disclosure refers to model training on a pre-training data set to adjust model parameters in a way that allows for subsequent adjustment of corresponding model parameters for one or more specific tasks. In some cases, pre-training may include self-supervised learning processes for training data with no designated labels, where the self-supervised learning process includes training in the structure of the pre-training example if there is no explicit label. Subsequent modification of the model parameters obtained through pre-training is referred to as “tuning.” Tuning can be performed on one or more tasks using supervised learning on explicitly labeled training data. In some cases, tasks different from those used in pre-training may be used for tuning.

Various artificial intelligence models included in the computing device may be configured with a plurality of modules stored in the memory. In the present disclosure, a module may refer to the configuration of a functional unit constituting a machine learning model. For example, the module may include, but is not limited to, an encoder, a decoder, a generator, a discriminator, an adapter, a natural language processing module, and a large language model (LLM).

The computing device may store the plurality of modules described above and build an artificial intelligence framework based on at least some of the modules to obtain an artificial intelligence model for data processing.

### [Hardware Configuration of the Computing Device]

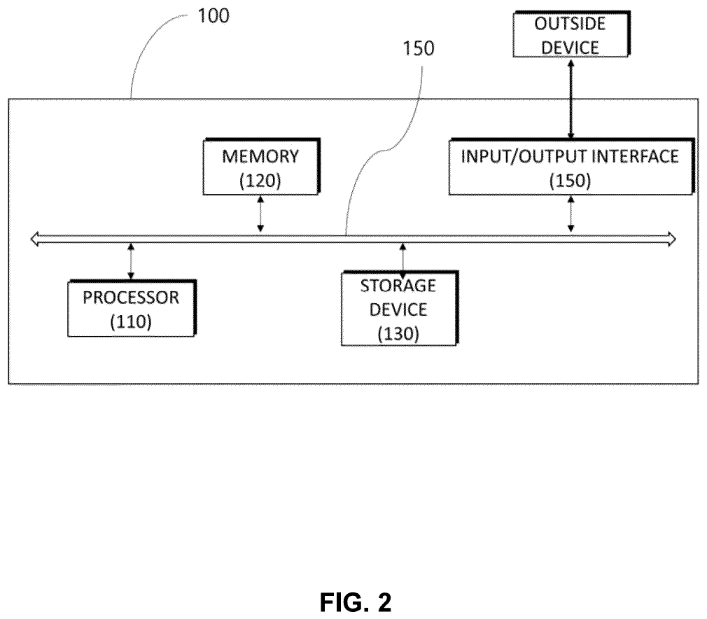

FIG. 2 is a diagram illustrating the configuration of a computing device included in the exemplary system (1) of FIG. 1 according to various embodiments.

Referring to FIG. 2, the computing device 100 (e.g., user device or computing device, hereinafter referred to as “computing device”) according to an embodiment may include a processor 110, a memory 120, a storage device 130, an input/output interface 140, and a communication bus 150. The configuration of the computing device 100 is not limited to the configuration illustrated in FIG. 2 or the above-described configuration. It may further include hardware or software configurations typically used in a general computing devices or mobile devices.

The processor 110 may include at least one processor with different portions providing different functions. For example, software (e.g., a program) may be executed to control at least one component (e.g., hardware or software) of the computing device 100 connected to the processor 110, and to perform various data processing or calculations. According to an embodiment, the processor 110 may store a command or data received from another component in the memory 120 (e.g., volatile memory), process the command or data stored in the volatile memory, and store the resultant data in the non-volatile memory. The processor 110 may include a main processor (e.g., a central processing unit or an application processor) or an auxiliary processor (e.g., a graphic processing unit, a neural network processing unit (NPU), an image signal processor, a sensor hub processor, or a communication processor) that operates independently of or in conjunction with the main processor. For example, when the computing device 100 includes the main processor and the auxiliary processor, the auxiliary processor may be configured to use lower power than the main processor or be specific to a designated function. The auxiliary processor may operate separately from or as part of the main processor and may control at least part of the functions or status of at least one component (e.g., display or communication circuit) when the main processor is inactive (e.g., sleep) or active (e.g., executing an application). The auxiliary processor may be operated as part of other components (e.g., communication circuits). The auxiliary processor (e.g., image signal processor or communication processor) may be operated as part of functionally related components. Additionally, the auxiliary processor (e.g., neural processing network) may include hardware specialized for processing an artificial intelligence model. The operation of the computing device 100 described below should be understood as the operation of the processor 110.

The memory 120 may include at least one memory unit with different portions providing different functions. The memory 120 may store various data used by at least one component (e.g., the processor 110) of the computing device 100. This data may include software (e.g., a program) and input or output data related to the software. The memory 120 may include both volatile and non-volatile memory. The memory 120 may store an operating system, middleware, applications, and/or the aforementioned artificial intelligence model.

Additionally, the memory 120 may include a plurality instructions for the processor 110 to execute functions provided by a service. The processor 110 may execute these instructions to provide the service functions based on the plurality of instructions stored in the memory 120.

The storage device 130 provides mass storage for the computing device 100 and may be a computer-readable medium. Examples of the storage device 130 include, but are not limited to, floppy disk drives, hard disk drives, optical disk drives, tape drives, flash memory devices, other solid-state memory devices, and device arrays such as storage area networks. In addition, a computer program product is clearly implemented in an information medium and includes instructions for performing one or more methods described herein when executed. The information medium can be a computer-readable or machine-readable medium such as the memory 120, the storage device 130, or the memory of the processor 110.

The input/output interface 140 may include an input interface connected to an input device receiving input signals and an output interface connected to an output device outputting output signals.

The communication bus 150 electronically (or communicatively) connects the various components of the computing device. Each component may be interconnected using various buses and mounted on a common motherboard or other suitable manner.

Additionally, the computing device 100 may include at least one communication circuit for communicating with an external device.

The communication circuit may establish a direct (e.g., wired) or wireless communication channel between the computing device 100 and an external computing device, and support communication performance through the established channel. The communication circuit may include one or more communication processors (e.g., communication chips) that operate independently of the processor 110 (e.g., program processor) and support direct or wireless communication. For example, the communication circuit may include a wireless communication module (e.g., a cellular communication module, a short-range wireless communication module, or a global navigation satellite system (GNSS) communication module), or a wired communication module (e.g., a local area network (LAN) communication module or a power line communication module). These modules may communicate with an external computing device through a short-range communication network (e.g., Bluetooth, Wi-Fi Direct, or IrDA) or a long-range communication network (e.g., a cellular network, 5G network, next-generation communication network, the Internet, or a computer network). The communication modules may be integrated into a single component (e.g., a single chip) or implemented as multiple separate components (e.g., multiple chips). The wireless communication module may identify or authenticate the computing device 100 within the communication network using subscriber information (e.g., IMSI: International Mobile Subscriber Identifier) stored in the subscriber identification module. The wireless communication module may support 4G networks, 5G networks, and next-generation communication technologies such as new radio access technology (NR), which supports high-speed transmission of high-capacity data (eMBB: enhanced mobile broadband), terminal power minimization and multiple terminal access (mMTC: massive machine type communication), or high reliability and low-latency communications (URLLC: ultra-reliable and low-latency communication). For example, the wireless communication module may support a high frequency band (e.g., mmWave band) to achieve a high data transmission rate, and various technologies for securing performance in the high frequency band such as beamforming, massive multiple-input and multiple-output (MIMO), full dimensional MIMO (FD-MIMO), array antennas, analog beam-forming, or large-scale antennas. The wireless communication module may support various requirements defined for the computing device 100, the endoscopic device, or the network system, including a peak data rate (e.g., 20 Gbps or more) for eMBB realization, loss coverage (e.g., 164 dB or less) for mMTC realization, or U-plane latency (e.g., 0.5 ms or less, or round trip 1 ms or less for downlink (DL) and uplink (UL) respectively) for URLLC realization.

The computing device 100 may include at least some of the above-described components (e.g., processor, communication circuit, memory, and display). For example, a user device may include a processor, a communication circuit, a memory, a sensor, and a display. Similarly, a server device may include a processor, a communication circuit, and a memory.

### [Functional Configuration of the Computing Device]

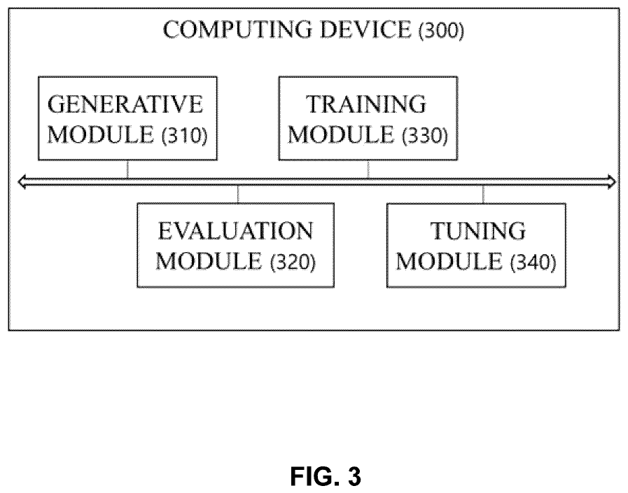

FIG. 3 is a diagram illustrating modules in which various data processing methods are performed by the computing device according to various embodiments. The module may include at least one hardware configuration or software configuration and may perform specific operations based on pre-stored instructions (e.g., code).

Referring to FIG. 3, the computing device 300 may include a generative module 310 for generating data, an evaluation module 320 for evaluating data, a training module 330 for training an artificial intelligence model by building a training data set, and a tuning module 340 for further training a pre-trained artificial intelligence model using data. The functional configuration of the computing device 300 is not limited to the above and may further include at least one module for performing general data processing methods.

The generative module 310 may generate synthetic data based on input data.

The evaluation module 320 may evaluate the generated synthetic data. Specifically, the evaluation module 320 may assess the quality of the generated synthetic data according to predetermined criteria. Additionally, the evaluation module 320 may evaluate an artificial intelligence model using the synthetic data. For instance, the evaluation module 320 may evaluate the performance of the artificial intelligence model by utilizing the synthetic data as evaluation data.

The training module 330 may train the artificial intelligence model using the synthetic data. Specifically, the training module 330 may build a training data set based on both synthetic data and actual data, and it may train the artificial intelligence model using this training data set.

The tuning module 340 may further train the pre-trained artificial intelligence model using the synthetic data. Specifically, the tuning module 340 may fine-tune the pre-trained artificial intelligence model based on the synthetic data, thereby acquiring the tuned model.

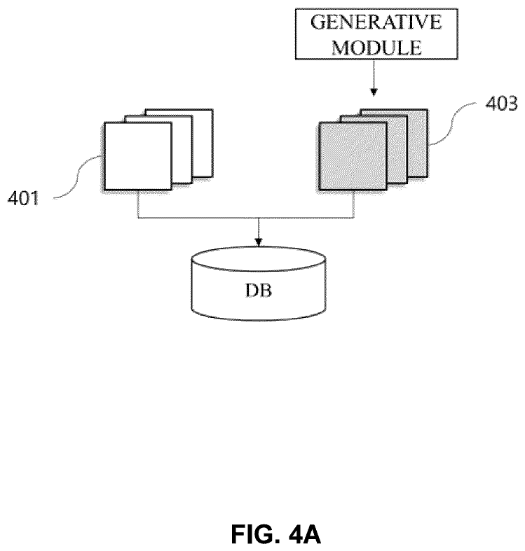

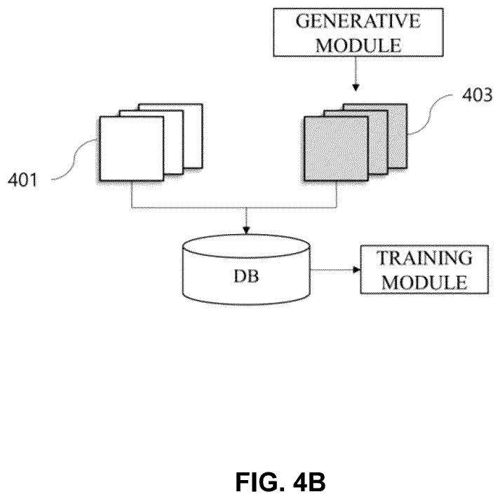

FIG. 4 is a diagram illustrating an example of processing data using at least one module included in a computing device according to various embodiments.

Referring to part (a) of FIG. 4, the computing device may store actual data 401 and synthetic data 403 generated by the generative module in a database (DB). The computing device may build a training data set based on the actual data 401 and the synthetic data 403.

Referring to part (b) of FIG. 4, the computing device may transmit the training data set built from the actual data 401 and synthetic data 403 to the training module. In this case, the training module may train the artificial intelligence model based on the training data set.

### [Generation of Synthetic Data]

The machine learning model for natural language processing includes a natural language understanding model aimed at inferring information from natural language and a natural language generative model aimed at generating natural language based on inputs. The training examples for the natural language understanding model may be task-specific. For example, to train the natural language understanding model to comprehend user utterances requesting travel to various destinations, a corpus for each task with label-designated training examples may be used. This corpus may include various examples of user utterances labeled by a human, where the labels may include intent labels (e.g., flight reservation, public transportation search) and slot labels (e.g., departure and arrival). For the purposes of this disclosure, the term “utterance” or “natural language input” includes not only words (verbal language) spoken by a user or a machine but also words conveyed via text, sign language, etc.

In many cases, training examples of human labeling used to train task-adaptive language understanding models are insufficient. Consequently, a model trained by using insufficient training examples may show low performance when applied to the corresponding task. The disclosed implementation provides a method for generating synthetic task-specific training examples, which can be used instead of or in addition to training examples created by actual users, using a generative model. In this disclosure, the term “synthetic” means that the data is generated at least in part by a machine. Generating training data for a natural language understanding model using the generative model does not require human to label the synthetic training examples. This approach enables the provision of large amounts of appropriate training data at a relatively low cost.

Existing techniques for training generative models do not necessarily produce generative models that are particularly useful for generating training examples for specific tasks. For instance, one method of non-guided training of the generative model involves training the model to predict the next word in a given sequence based on a previously seen word. However, if the training data used in the generative model is a general-purpose corpus (e.g., Wikipedia articles, books, web articles), the trained generative model learns to generate text similar to that found in the general-purpose corpus. This approach can produce a generative model capable of producing reasonable utterances, but such a model may lack utility for specific natural language scenarios.

For example, “conversation behavior” has significant utility in user-facing applications such as interactive bots or digital assistants. Automated applications can interpret received user utterances using the natural language understanding model to infer intentions and slot values from the spoken or input words. Additionally, the automated applications can generate response utterances to the user using the generative model.

However, a generative model trained on a general-purpose corpus (e.g., Wikipedia articles) may not be particularly adept at generating synthetic utterances suitable for conversational behavior in user-facing scenarios. Moreover, the synthetic data (e.g., synthetic utterances) generated by such a model may not closely resemble user requests for a conversation-based system, making it less useful as synthetic training data for the natural language understanding model intended to comprehend user conversations.

According to an embodiment of the present disclosure, a computing device can provide synthetic data using the aforementioned natural language processing model (e.g., a natural language understanding model or a generative model).

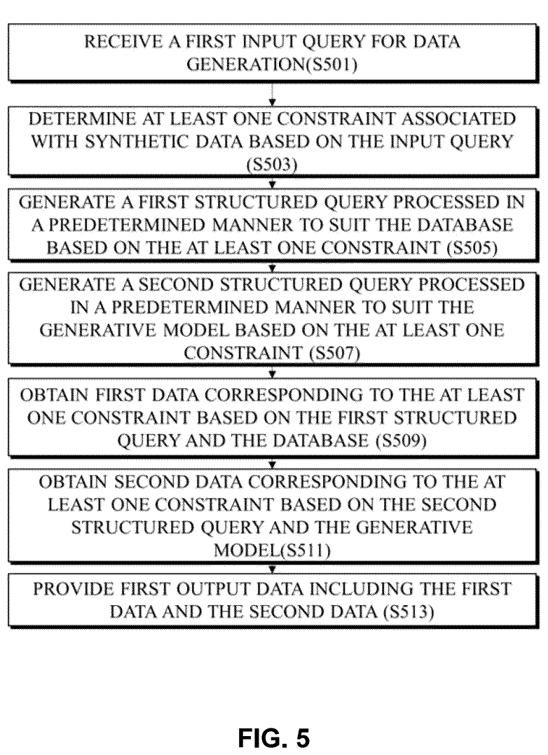

FIG. 5 is a flowchart illustrating an embodiment in which a computing device generates data according to various embodiments.

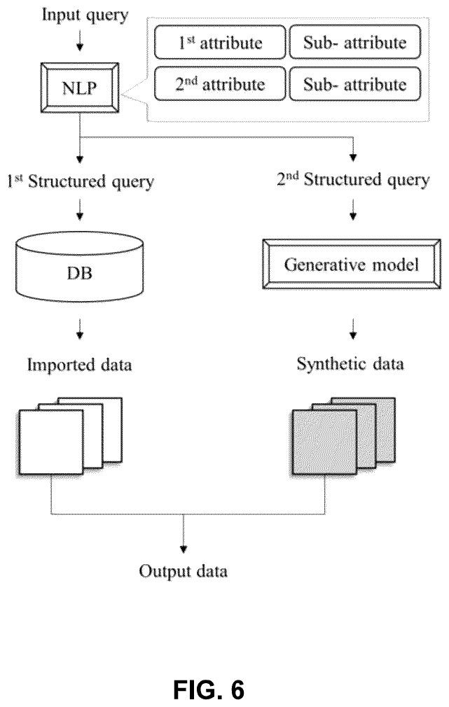

FIG. 6 is a diagram illustrating an example of a framework in which a computing device generates data according to various embodiments.

Referring to FIG. 5, the computing device or at least one processor included in the computing device may be configured to perform the following operations: to receive a first input query for data generation (S501); to determine at least one constraint associated with synthetic data based on the input query (S503); to generate a first structured query processed in a predetermined manner suitable for the database based on the at least one constraint (S505); to generate a second structured query processed in a predetermined manner suitable for the generative model based on the at least one constraint (S507); to obtain first data corresponding to the at least one constraint based on the first structured query and the database (S509); to obtain second data corresponding to the at least one constraint based on the second structured query and the generative model (S511); and to provide first output data including the first data and the second data (S513).

Referring to FIG. 6, the at least one processor may receive a first input query for data generation from the client device. This input query may include a natural language query input from the client device, containing information about the data to be generated. For example, the query may be a natural language input requesting data generation such as “generating waste plastic data” or requesting data generation for training a specific artificial intelligence model such as “generate data for training a model to classify animals in images.”

The processor may perform natural language processing based on the input query to determine at least one constraint associated with the synthetic data. Specifically, the processor may input the query into a natural language processing (NLP) model to determine constraints using the NPL model. This pre-processing step (S503) involves converting the natural language input into a form suitable for data generation before the processor generates data based on the natural language input.

Constraints may include attributes (e.g., property of data) or characteristics of the data to be generated. For example, the processor may extract at least one attribute (e.g., degree of crumpling of plastic) or at least one sub-attribute (e.g., flavor) from the input query. Constraints could also include the modality (e.g., image or text) or domain (e.g., animal or plastic) of the data.

For example, the processor may determine at least one constraint, including a first attribute and a second attribute of the data, based on the input query. Specifically, the processor may determine constraints such as the modality of the data (e.g., image or text) or the domain of the data (e.g., animal or plastic) based on the input query, but it is not limited to these examples.

Additionally, the constraints may include sub-attributes of the data to be generated. For example, the processor may determine constraints that include a primary attribute (e.g., domain of data, such as animal) and a sub-attribute (e.g., dog) based on the input query. In this case, the computing device may generate data related to dogs.

The more detailed the information included in the input query, the more specific the constraints that can be determined. This means that the characteristics of the generated data will be more closely aligned with the conditions specified in the input query.

Constraints may also be associated with the user's intention derived from the input query. Specifically, the processor may determine constraints by understanding the user's intention based on the natural language query.

The computing device may generate synthetic data based on the user's input query for data generation. Additionally, it can retrieve data corresponding to the input from a database (DB) and provide both the synthetic and retrieved data. The processor may generate a first structured query suitable for the database based on the constraints. This first structured query may be used to search for data in the database that corresponds to the constraints. The processor may obtain the first structured query based on the first input query by reflecting the at least one constraint. For example, the processor may obtain the first structured query by extracting at least one keyword or search path corresponding to the constraint. The processor may convert the natural language query structure into a database query structure.

The processor may obtain imported data corresponding to the at least one constraint based on the first structured query and the database. The imported data is data pre-stored in the database, and it may be data retrieved by the processor from the database based on the constraint.

Additionally, the processor may generate a second structured query suitable for the generative model based on the constraint. The second structured query may be a prompt for generating data corresponding to the at least one constraint in the generative model. Specifically, the processor may obtain the second structured query by extracting a prompt based on the input query. The processor may obtain the second structured query by extracting at least one keyword corresponding to the constraint based on the first input query. The structure of the second structured query may be different from that of the first structured query. The processor may convert the structure of the natural language query into a prompt structure for the generative model.

The processor may identify whether the second structured query is obtainable based on the input query. Specifically, the processor assesses whether the input query contains sufficient information about the data to be generated. If the input query is sufficiently detailed, the second structured query is generated based on the information in the input query. If the information about the data to be generated is insufficient, the processor may provide feedback to the client device (e.g., requesting additional information for the input query).

The processor may obtain synthetic data corresponding to at least one constraint based on the second structured query and the generative model. The synthetic data, generated by the generative model, may be data output by providing a prompt reflecting the constraint to the generative model.

The processor may provide output data that includes both imported data obtained from the database and synthetic data obtained from the generative model. In this case, the output data may be provided through the output interface of the client device. The output data may include imported data, synthetic data, and information related to both types of data.

This process allows users to receive synthetic data generated in response to the user's input query and the pre-stored imported data corresponding to the query.

The computing device may provide a user interaction method for data based on inputs from the client device.

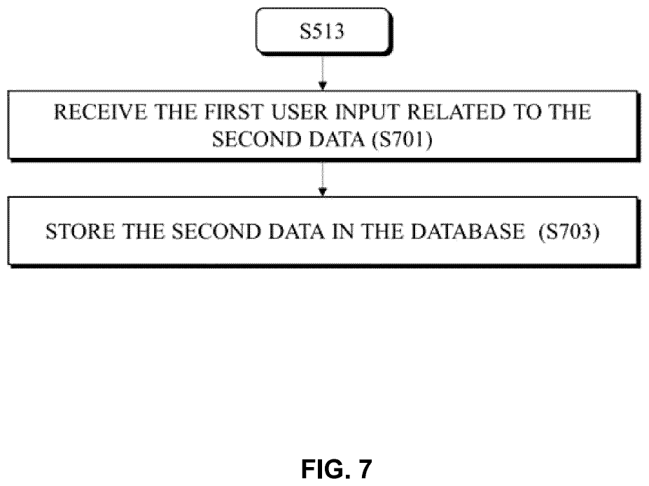

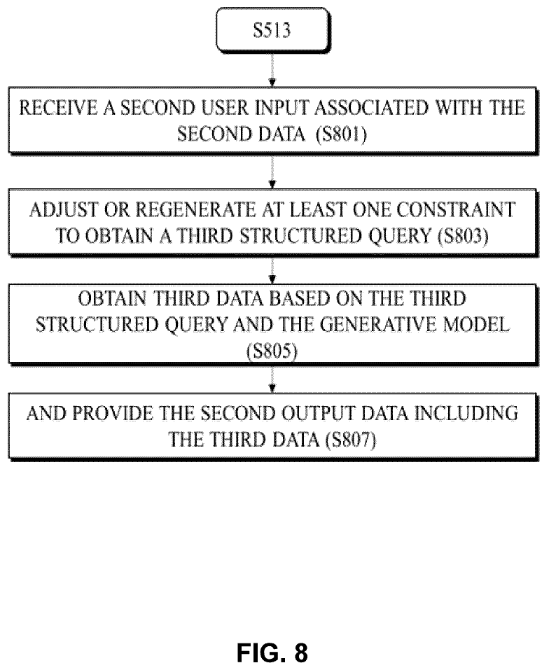

FIGS. 7 and 8 are diagrams for describing a user interaction method for output data.

Referring to FIG. 7, the at least one processor in the computing device or the computing device may be configured to receive the first user input related to the second data (S701) and store the second data in the database (S703) after providing the first output data according to operation S513. Specifically, the processor may receive the first user input for the second data generated by the generative model. The first user input may confirm the generation of the data and instruct the completion of the data generation process. For example, the first user input may include an approval, a selection, a confirmation for the second data or an indication of completion for the data generation process. The processor may store the second data into the database when the first user input is received.

Referring to FIG. 8, the processor in the computing device or the computing device may be configured to receive a second user input associated with the second data (S801) after providing the first output data according to operation S513, adjust or regenerate at least one constraint to obtain a third structured query (S803), obtain third data based on the third structured query and the generative model (S805), and provide the second output data including the third data (S807).

Specifically, the processor may receive a second user input for the second data generated by the generative model. The second user input may be an input instructing to adjust the generated data or regenerate data, which leads the processor to refine the constraints and generate new data accordingly. The second user input may be an additional input associated with the data generation. For example, the second user input may include a rejection input, a feedback input, or a modification input for the second data. The second user input may be an input instructing to perform the data generation process again. This user interaction process for generating and adjusting synthetic data may ensure the user's intentions are accurately reflected in the generated data.

The processor may adjust or regenerate at least one constraint associated with the data generation to obtain the third structured query. In this case, the third structured query may include a prompt that is regenerated to input to the generative model. The processor may provide the third structured query to the generative model to obtain the third data through the generative model. Additionally, the processor may provide the second output data including the third data to the client device.

In addition, the user interaction for the third data may be equally applied to the process described in FIGS. 7 and 8.

According to an embodiment of the present disclosure, the computing device may further identify the intention of the user using the pre-stored data. Specifically, the computing device may provide the pre-stored data from the database to the user based on the input query before generating new data. The computing device may identify the user's intention based on the user input for the provided data. For example, the computing device may determine whether the input query aims to generate data similar to the provided data.

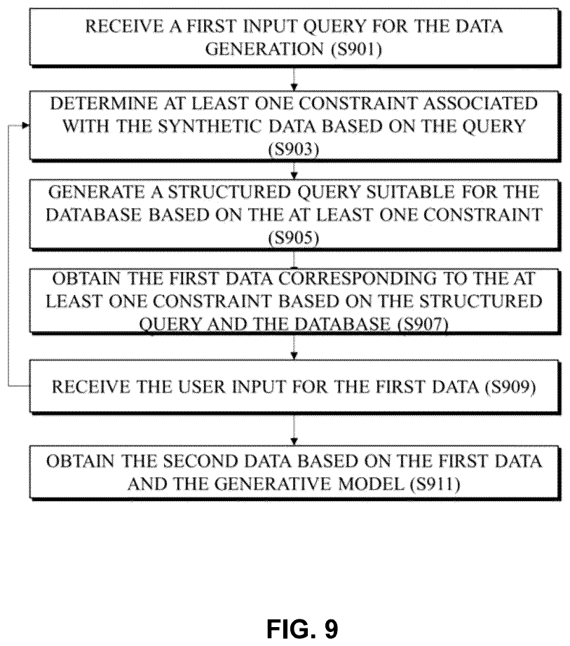

FIG. 9 is a flowchart illustrating another embodiment in which the computing device generates data according to various embodiments.

Referring to FIG. 9, the processor in the computing device or the computing device may be configured to receive a first input query for the data generation (S901), determine at least one constraint associated with the synthetic data based on the query (S903), generate a structured query suitable for the database based on the at least one constraint (S905), obtain the first data corresponding to the at least one constraint based on the structured query and the database (S907), receive the user input for the first data (S909), obtain the second data based on the first data and the generative model (S911). These operations (S901, S903, S905, S907) may be equally applied to the processor described in FIG. 5.

The processor in the computing device or the computing device may provide the first data obtained from the database to the client device and receive a user input for the first data from the client device.

For instance, if the processor may receive a first user input (e.g., an approval input) for the first data, the processor may generate the second data based on the first data and the generative model. Specifically, the processor provides the first data to the generative model and generate the second data through the generative model. The processor may provide the first data and the query to the generative model and generate the second data through the generative model. Alternatively, the processor may generate a structured prompt based on the first input query, provide the structured prompt to the generative model, and generate the second data through the generative model.

In addition, if the processor may receive a second user input (e.g., a rejection input) for the first data, the processor may re-determine at least one constraint in response to the second user input and generate new data.

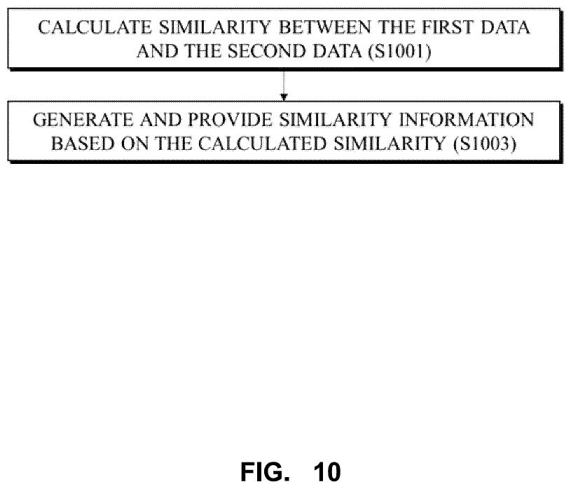

FIG. 10 is a diagram illustrating a method of providing similarity information between data by a computing device according to various embodiments.

Referring to FIG. 10, the processor in the computing device or the computing device may be configured to determine similarity between the first data and the second data (S1001) and provide similarity information based on the determined similarity (S1003).

The processor may provide similarity information indicating similarity between the first data retrieved from the database and the second data generated from the generative model to the client device.

The similarity between the first data and the second data may be determined by calculating a distance between the first data and the second data in the embedding space, such as geometric distance (e.g., Euclidean distance). The similarity may be determined based on the distance in the embedding space where the first data and the second data are defined in a specific dimension.

The computing device may generate and provide information on the quality of the second data generated by the generative model, based on the similarity to the existing data (e.g., the first data). A detailed method of evaluating the quality of the generated data and providing the quality information will be described below.

### [Evaluation]

The computing device according to an embodiment of the present disclosure may provide an evaluation solution for data or an artificial intelligence model. Specifically, the computing device may be configured to perform evaluation of synthetic data or evaluation of an artificial intelligence model using synthetic data based on a pre-stored manner.

For example, the computing device may use the synthetic data as the evaluation data of the artificial intelligence model. Specifically, the computing device may provide the generated synthetic data to the artificial intelligence model and evaluate the artificial intelligence model based on the output result data.

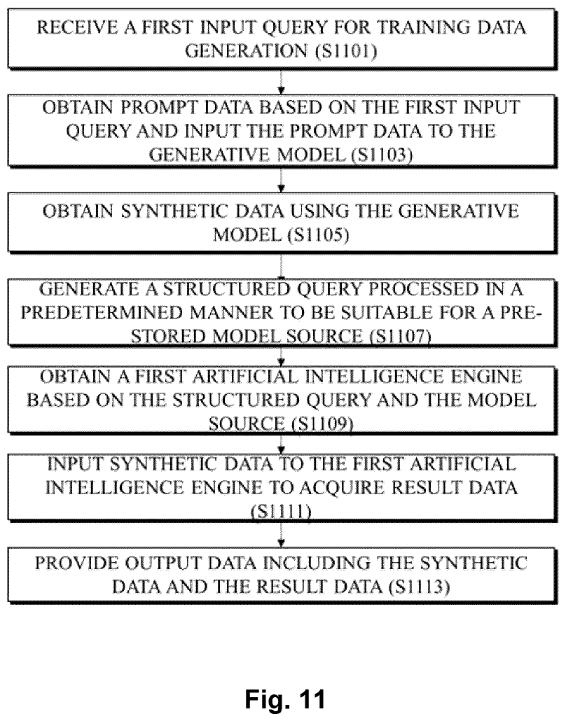

FIG. 11 is a flowchart illustrating a method of evaluating using synthetic data according to various embodiments.

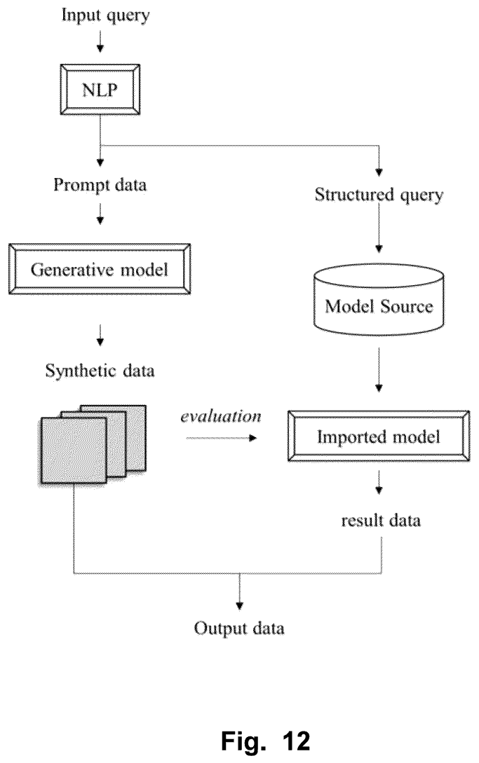

FIG. 12 is a diagram illustrating an example of a framework for providing a method of evaluating using synthetic data according to various embodiments.

Referring to FIG. 11, at least one processor in the computing device or the computing device may generate synthetic data to evaluate the artificial intelligence model.

Specifically, the processor in the computing device or the computing device may be configured to receive a first input query for training data generation (S1101), obtain prompt data based on the first input query and input the prompt data to the generative model (S1103), obtain synthetic data using the generative model (S1105), generate a structured query processed in a predetermined manner to be suitable for a pre-stored model source (S1107), obtain a first artificial intelligence engine based on the structured query and the model source (S1109), inputting synthetic data to the first artificial intelligence engine to acquire result data (S1111), and providing output data including the synthetic data and the result data (S1113).

Referring to FIG. 12, the processor may receive an input query from the client device. The input query may include a natural language query. The client device may transmit a request for data generation for training an artificial intelligence model. For example, the input query may include a natural language input requesting generating data for training or evaluating the artificial intelligence model having a specific purpose. The input query could be “generate data for training a model to classify an animal,” “generate data for evaluating a model classify an animal,” or “generate image data for training a perception model.” The computing device may transmit feedback related to the input query to the client device if the input query does not meet predetermined criteria. For instance, the computing device may transmit a request of additional information to the client device when the essential items in the input query are missing.

The processor may process the input query to obtain prompt data, inputting the input query to a natural language processing model (NLP) and obtaining prompt data through the natural language processing model. For example, the processor may obtain prompt data by extracting at least one keyword based on the input query. The processor may generate prompt data by determining requirements of data to be generated based on the input query. For instance, when an input query such as “generate image data for training a model for classifying an animal” is input, the processor may obtain prompt data based on a keyword such as “animal” and “image” etc.

The at least one processor may provide the prompt data to a generative model to generate synthetic data. The processor may obtain synthetic data from at least one output layer of the generative model.

The computing device may utilize at least one artificial intelligence model in the model source as an auxiliary network (aux-net). The processor may retrieve the synthetic model corresponding to the input query from the model source by performing pre-processing on the input query.

Specifically, the processor may obtain a structured query based on the input query, processing the input query in a pre-determined manner suitable for the pre-stored model source to obtain the structured query. The structured query may be used to search for the model from the model source.

The processor may obtain an imported model by searching for at least one artificial intelligence model corresponding to the input query from the model source based on the structured query. The imported model may include the synthetic model retrieved from the model source.

The processor may provide the synthetic data to the imported model, evaluating its performance of the imported model using the synthetic data as evaluation data. The processor may obtain result data from the imported model in which the synthetic data is input. The result data may indicate the performance (e.g., accuracy, precision) of the imported model. The processor may provide output data, including the synthetic data and the result data, to the client device.

According to the embodiments of the present disclosure, the computing device may evaluate the artificial intelligence model using the synthetic data generated in response to a request from the user. The processor provides the synthetic data and the evaluation results to the client device, facilitating user assessment of the reliability and quality of generated synthetic data.

The computing device may evaluate the quality of the generated synthetic data using a generative model. Specifically, the computing device may provide the generated synthetic data to the pre-stored evaluation model and evaluate its quality based on the output result data.

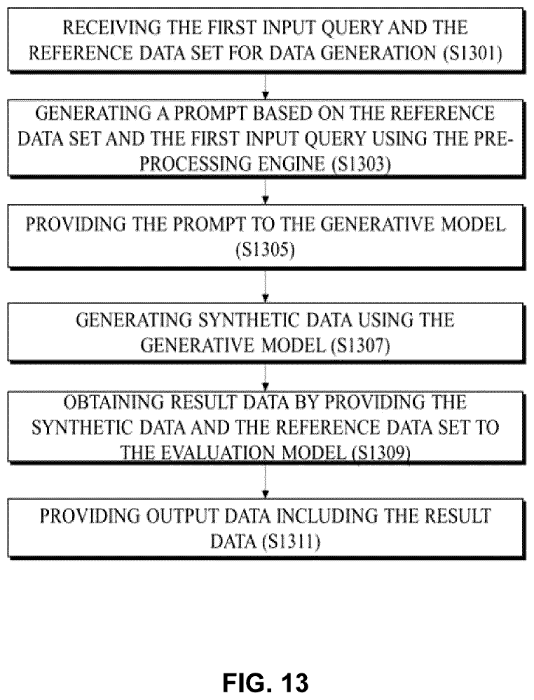

FIG. 13 is a flowchart describing a method for evaluating synthetic data by a computing device according to various embodiments.

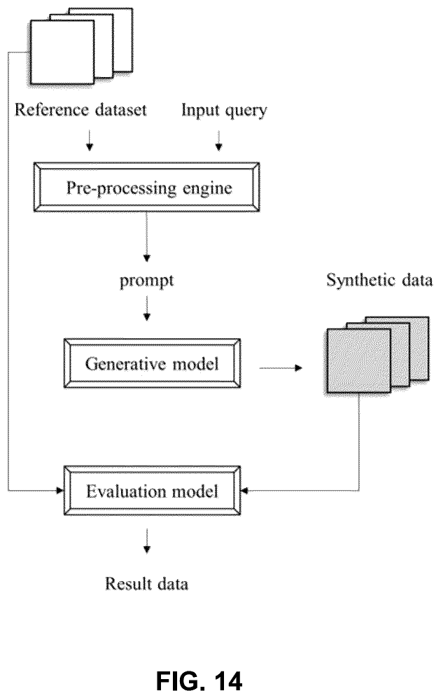

FIG. 14 is a diagram illustrating a framework for evaluating synthetic data by a computing device according to various embodiments.

Referring to FIG. 13, the at least one processor in the computing device or the computing device may generate and evaluate the synthetic data. Specifically, the processor or the computing device may perform the following operations: receiving the first input query and the reference data set for data generation (S1301), generating a prompt based on the reference data set and the first input query using the pre-processing engine (S1303), providing the prompt to the generative model (S1305), generating synthetic data using the generative model (S1307), obtaining result data by providing the synthetic data and the reference data set to the evaluation model (S1309), and providing output data including the result data (S1311).

Referring to FIG. 14, the processor may receive the input query and the reference data set from the client device. The input query may include a natural language query input from the client device. Detailed descriptions about the input query have been provided above. The reference data set serves as a benchmark for the data to be generated. The processor may use the reference data set and the input query to generate data that aligns with the user's intent.

For example, the client device may request the generation of data similar to the reference set having at least one attribute (e.g., modality). The processor may generate synthetic data similar to the reference data set having at least one attribute.

The processor may provide the reference data set and the input query to the pre-processing engine. The pre-processing engine includes at least one module for processing the input query and include at least one natural language processing engine for processing the input query. In addition, the pre-processing engine include at least one multi-modal engine for analyzing the relationship between the input query and the reference data set.

The processor may generate a prompt for the generative model based on the reference data set and the input query by using the pre-processing engine. The prompt may be generated by determining at least one constraint for the data to be generated. The processor provides the prompt to the generative model and generates synthetic data from the generative model. The processor may obtain synthetic data from at least one output layer of the generative model.

The processor may provide the synthetic data and the reference data set to the evaluation model. The processor obtains the result data indicating the quality of the data from the evaluation model. The processor may provide the output data including the result data to the client device.

The evaluation model, an artificial intelligence model with at least one logic for evaluate the quality of the data. The evaluation model evaluates the quality of the data by determining intrinsic characteristics of the data, such as the distribution, the density, and the bias of the data.

The processor may evaluate the similarity between the synthetic data and the reference data set in an embedding space defined in a specific dimension. The processor may evaluate the quality of the synthetic data based on the distribution of the reference data set and the synthetic data in the embedding space. The processor may determine that the quality of the synthetic data is higher if it is more similar to the reference data set.

Additionally, the processor may evaluate the data's homogeneity using the evaluation model. The processor may determine that the quality of the synthetic data is higher if the data is more homogeneous (e.g., the density is constant) as the synthetic data is added to the reference data set.

The processor may evaluate the bias of the data using the evaluation model. The processor may determine that the quality of the synthetic data is higher if the bias of the data is decreased as the synthetic data is added to the reference data set.

### [Building of Training Data Set, Artificial Intelligence Model Training and Tuning]

According to various embodiments of the present disclosure, the computing device may build a training data set for training the artificial intelligence model using the pre-built data (e.g., actual data) and the generated data (e.g., synthetic data). In particular, the computing device may use the synthetic data generated from the generative model to train the artificial intelligence model by verifying the synthetic data according to a predetermined criterion.

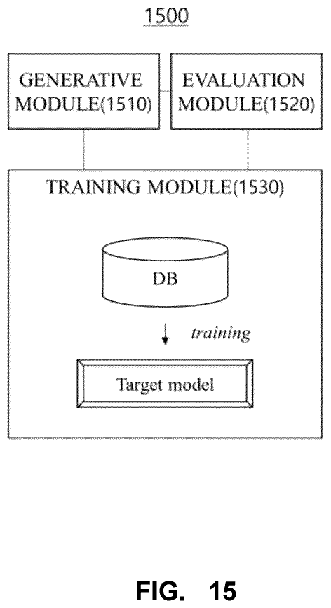

FIG. 15 is a diagram illustrating configurations for the computing device to build the training data set and train the artificial intelligence model according to various embodiments.

Referring to FIG. 15, the computing device 1500 may include a generative module 1510 for generating synthetic data, an evaluation module 1520 for evaluating the generated synthetic data, and a training module 1530 for training the artificial intelligence model.

The generative module 1510 may generate the synthetic data using the at least one generative model based on a user input (e.g., an input query, a prompt input). The evaluation module 1520 may evaluate the synthetic data generated by the generating module 1510 according to a predetermined criterion. A detailed description of the generating and evaluation methods performed by the generating module 1510 and the evaluation module 1520 will be omitted as it has been described above. The training module 1530 may build the training data set (DB) based on the generated data and/or the verified data evaluated by the evaluation module 1520 and train a target model.

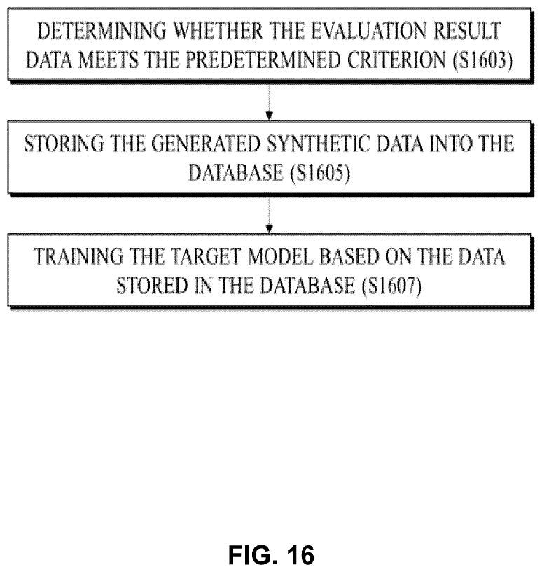

FIG. 16 is a flowchart describing a method in which the computing device uses the verified synthetic data.

Referring to FIG. 16, the computing device or the at least one processor in the computing device may build a training data set using synthetic data verified according to a predetermined criterion and train the artificial intelligence model.

Specifically, the at least one processor may perform operation of determining whether the evaluation result data meets the predetermined criterion (S1603), storing the generated synthetic data into the database (S1605), and training the target model based on the data stored in the database (S1607).

The at least one processor may obtain the evaluation result data by assessing the synthetic data generated from the generative model in a predetermined manner. A detailed description of the evaluation method is omitted here as it has been described above.

The at least one processor may determine whether the evaluation results meet the predetermined criterion. Specifically, the processor may assess whether the synthetic data is suitable for training the artificial intelligence model. For example, the processor may determine whether the quality of the synthetic data, identified based on the evaluation result data, is equal to or greater than the predetermined quality criterion.

If the evaluation result meets the predetermined criterion, the processor may store the synthetic data in the database. If the evaluation result does not meet the predetermined criterion, the processor may not store the synthetic data in the database, and it may adjust or generate the synthetic data.

In addition, the processor may train the target model based on the data stored in the database. The target model may be an artificial intelligence model being trained. The processor may retrieve the target model from the model source and train the target model using the training data set built in the database.

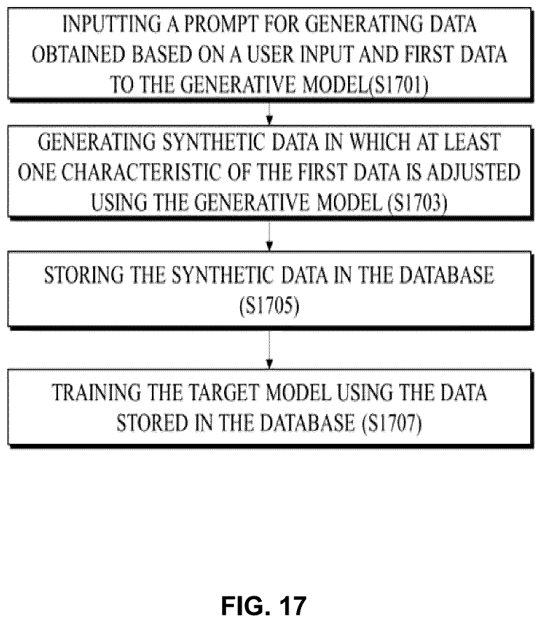

FIG. 17 is a flowchart illustrating a method for a computing device to train an artificial intelligence model according to various embodiments.

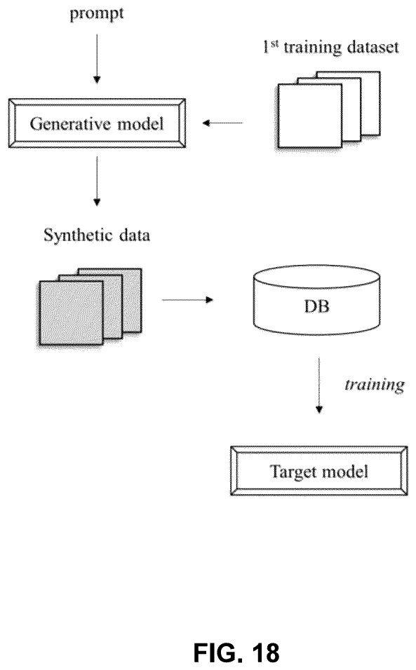

FIG. 18 is a diagram illustrating an example of framework for a computing device to train an artificial intelligence model according to various embodiments.

Referring to FIG. 17, the at least one processor in the computing device or the computing device may perform operation of inputting a prompt for generating data obtained based on a user input and first data to the generative model (S1701), generating synthetic data in which at least one characteristic of the first data is adjusted using the generative model (S1703), storing the synthetic data in the database (S1705), and training the target model using the data stored in the database (S1707).

For example, referring to FIG. 18, the at least one processor may obtain a prompt based on the user input. The prompt may include a natural language input indicating data generation. The processor may obtain a first training data set from the database.

The processor may provide the prompt and the first training data set to the generative model which generates data reflecting the prompt's instructions. The generative model may generate synthetic data similar to the first training data set, but it is not limited thereto.

The processor may generate synthetic data to improve the quality of the training data set and expand the coverage of the training data set. The synthetic data helps the artificial intelligence model to train various data on data scenarios, ensuring high performance. Specifically, the processor adjusts at least one characteristic of the first training data set using the generative model to create synthetic data.

The processor may store the generated synthetic data in the database (DB), resulting in a second training data set that includes the synthetic data. The second training data set may have a broader coverage, more homogeneous density, less bias, and higher quality compared to the first training data set. The processor may train the target model using the second training data set stored in the database.

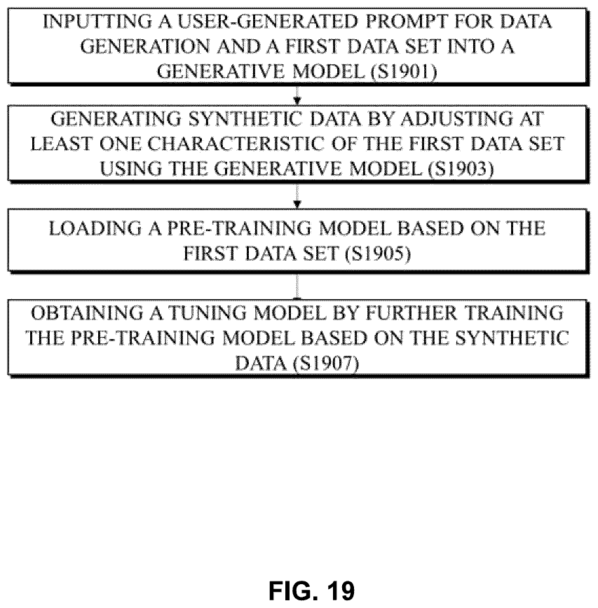

FIG. 19 is a flowchart illustrating a method for a computing device to tune a pre-training model according to various embodiments.

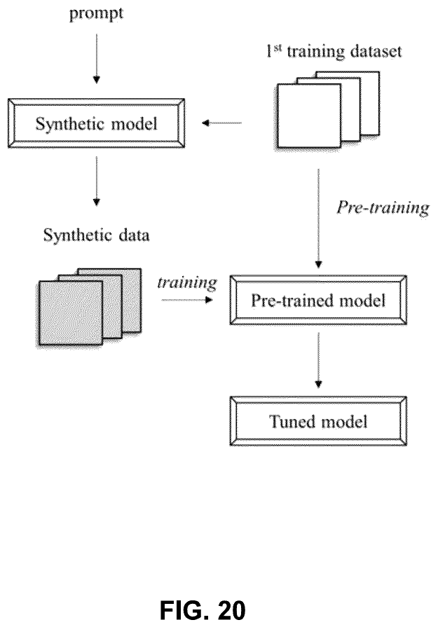

FIG. 20 is a diagram illustrating an example of a framework for a computing device to tune a pre-training model according to various embodiments.

Referring to FIG. 19, the at least one processor in the computing device or the computing device may perform operation of inputting a user-generated prompt for data generation and a first data set into a generative model (S1901), generating synthetic data by adjusting at least one characteristic of the first data set using the generative model (S1903), loading a pre-training model based on the first data set (S1905), and obtaining a tuning model by further training the pre-training model based on the synthetic data (S1907).

For example, referring to FIG. 20, the at least one processor may acquire a prompt based on a user input. The prompt may include a natural language instruction for data generation. The processor may also obtain a first training data set for the database. The processor may provide the prompt and the first training data set to a generative model, which generates data reflecting the prompt's instructions. The generative model may generate synthetic data similar to the first training data set, but it is not limited thereto. The processor may adjust at least one characteristic of the first training data set using the generative model to create synthetic data. The first training data set may be used to train the pre-training model.

The processor may generate synthetic data to fine-tune the pre-training model according to the user's intention using the generative model. Specifically, the processor may generate synthetic data for domain adaptation based on prompt input of the pre-training model. The synthetic data may be conditioned by the prompt based on the first training data set. For example, the processor may generate synthetic data having domains determined by prompt and the synthetic data may maintain the same modality as the first training data set.

The processor may load the pre-training model based on the first training data set and obtain a tuned model by further training the pre-training model with the synthetic data. The pre-training model may be obtained from the model source. The processor may store the tuned model in the model source.

### [User Interface and Interaction]

According to an embodiment of the present disclosure, the computing device may generate synthetic data based on a user's prompt input and provide the generated synthetic data to the client device. Additionally, the computing device may provide the user interaction function associated with the synthetic data. For example, the computing device may present multiple user interfaces on the client device. The user interfaces may implement various functions associated with the synthetic data.

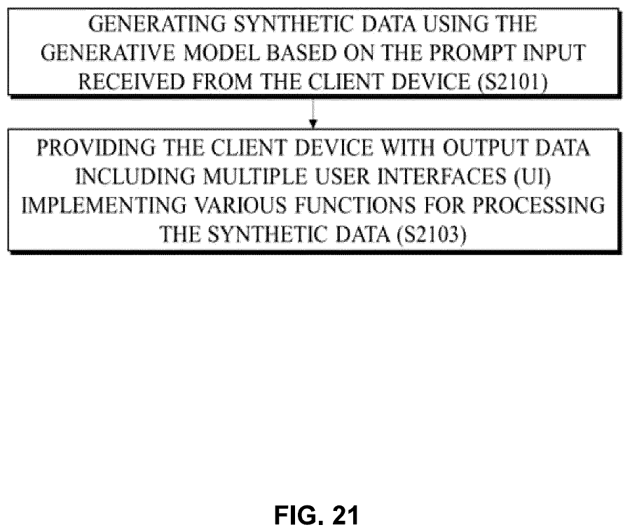

FIG. 21 is a flowchart illustrating a method for providing a user interaction function for synthetic data by a computing device according to various embodiments.

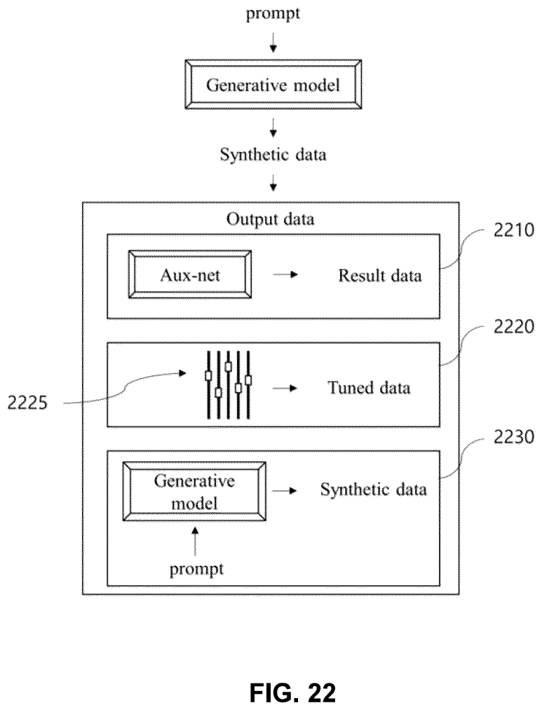

FIG. 22 is a diagram showing examples of various user interaction functions provided by the computing device according to various embodiments.

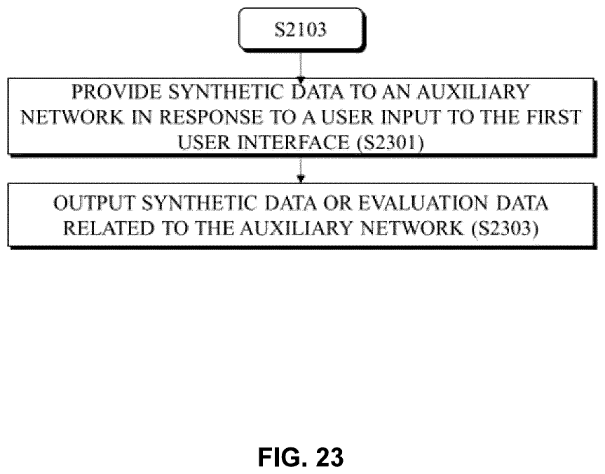

FIGS. 23 to 25 are diagrams illustrating example flowcharts of user interactions provided by the computing device.

Referring to FIG. 21, the at least one processor in the computing device or the computing device may perform the following operations: generating synthetic data using the generative model based on the prompt input received from the client device (S2101) and providing the client device with output data including multiple user interfaces (UI) implementing various functions for processing the synthetic data (S2103).

For example, referring to FIG. 22, the at least one processor may obtain synthetic data by providing the prompt input from the client device to the generative model. The processor may provide the client device with output data including the user interfaces implementing various functions associated with the synthetic data.

The at least one processor may provide the first user interface 2210 for using the auxiliary network. Specifically, the processor may provide output data, including synthetic data and at least one auxiliary network (Aux-net), to the client device. The auxiliary network may be loaded from a model source. The processor may retrieve at least one auxiliary network from the model source based on the user input. Additionally, the processor may input synthetic data to the auxiliary network based on the user input and output result data through the auxiliary network.

Referring to FIG. 23, the processor in the computing device or the computing device may perform operations to provide synthetic data to an auxiliary network in response to a user input to the first user interface (S2301) and output synthetic data or evaluation data related to the auxiliary network (S2303).

For example, the processor may provide an artificial intelligence model for evaluation to an auxiliary network. The processor may output result data indicating the performance of the artificial intelligence model by inputting synthetic data as evaluation data.

The processor may provide an evaluation model for evaluating synthetic data to an auxiliary network. The processor may output result data indicating the quality of the synthetic data by inputting the synthetic data to the auxiliary network.

Referring to FIG. 22, the processor may provide a second user interface 2210 for adjusting characteristics of synthetic data. Specifically, the processor may provide the output data including a first attribute object 2225 corresponding to the at least one attribute value of the generated synthetic data to the client device. In addition, based on the user input for the first attribute object 2225, the processor may modify these attributes and provide the modified data to the client device.

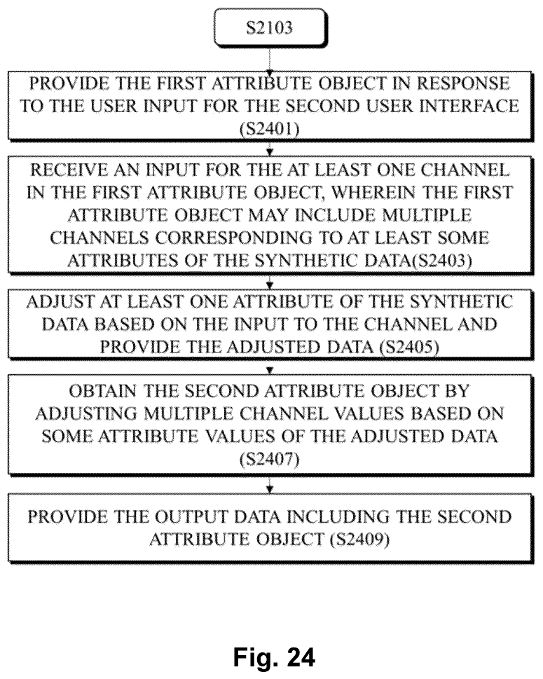

Referring to FIG. 24, the processor may provide the first attribute object in response to the user input for the second user interface (S2401). The processor may receive an input for the at least one channel in the first attribute object, wherein the first attribute object may include multiple channels corresponding to at least some attributes (e.g., color, texture, sharpness, and contrast of synthetic data) of the synthetic data (S2403).

In addition, the processor may adjust at least one attribute of the synthetic data based on the input to the channel and provide the adjusted data (S2405). Specifically, the processor may obtain the adjusted data by adjusting at least one attribute value of the synthetic data based on the user input for adjusting the channel value and provide the adjusted data to the client device.

The processor may obtain the second attribute object by adjusting multiple channel values based on some attribute values of the adjusted data (S2407). Specifically, the processor may generate a second attribute object indicating multiple attribute values of the adjusted data and provide the generated second attribute object to the client device. The processor may obtain the second attribute object based on the user input for the first attribute object. In addition, the processor may provide the output data including the second attribute object (s2409).

In addition, the processor may provide the attribute object indicating at least one attribute of the data set (or data group). Specifically, the processor may provide the attribute object indicating the relationship between the data included in the data set. For example, the processor may provide the attribute object based on the similarity graph indicating the relationship between the data. The processor may provide the attribute object (e.g., the image of data) indicating the data distribution in the data set. The processor may adjust the attribute of the data set based on the user input for the attribute object.

Referring to FIG. 23, the at least one processor may provide a third user interface 2230 for generating synthetic data again. Specifically, the processor may provide the output data including the generative model to the client device. When an additional prompt input is received through the third user interface, the generative model may generate synthetic data.

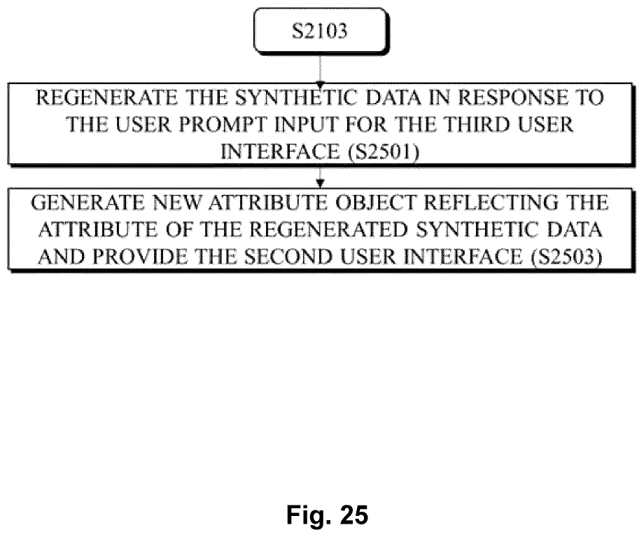

Referring to FIG. 25, the at least one processor may regenerate the synthetic data in response to the user prompt input for the third user interface (S2501). The prompt input may include feedback for the existing generated synthetic data. For example, the prompt input may include a natural language input which adjusts the attribute of the generated synthetic data or generates new synthetic data. The processor may generate new attribute object reflecting the attribute of the regenerated synthetic data and provide the second user interface (S2503). The computing device may provide a solution for generating synthetic data reflecting user intention through various user interfaces.

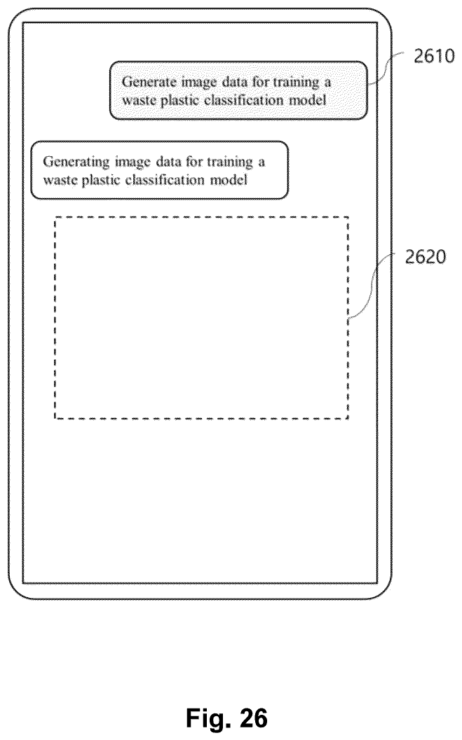

FIGS. 26 to 29 are diagrams illustrating examples of user interfaces for processing synthetic data provided by the computing device according to various embodiments.

The computing device may provide a solution for generation and processing of synthetic data based on an input received from the client device by providing an interactive interface.

Referring to FIG. 26, the computing device may provide the output data 2620 including the synthetic data corresponding to the first prompt input 2610 based on the first prompt input 2610 (e.g., “Generate image data for training a waste plastic classification model”) from the client device. In this case, the processor may provide the output data 2620 along with the response 2610 (e.g., “Generating image data for training a waste plastic classification model”).

The computing device may verify the user input (e.g., query input or prompt input) requesting the data generation in a predetermined manner. The processor in the computing device may verify the user input based on whether the user input sufficient information for the data generation.

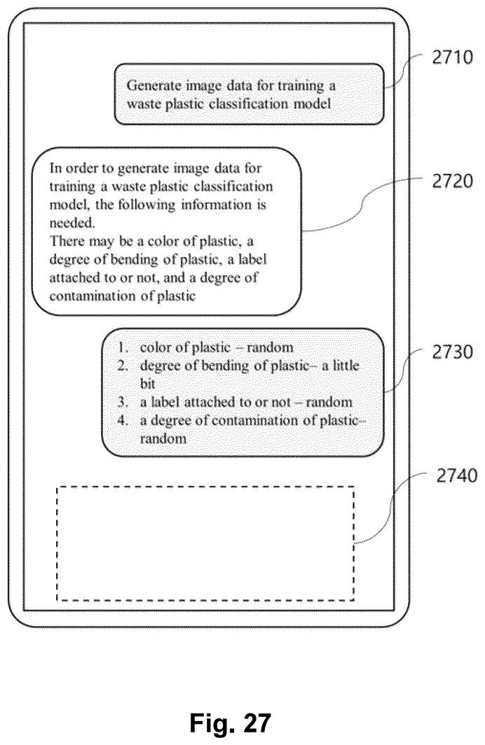

Referring to FIG. 27, the processor in the computing device may receive a first prompt input 2710 requesting the data generation from the client device. The processor may verify the first prompt input 2710 based on the information in the first prompt input 2710.

If additional information is needed after verifying the first prompt input 2710, the processor may provide a first response 2720 requesting further information to the client device. The first response 2720 may include text (e.g., “In order to generate image data for training a waste plastic classification model, the following information is needed. There may be a color of plastic, a degree of bending of plastic, a label attached to or not, and a degree of contamination of plastic”).

When the second prompt input 2730 including the further information is received, the processor may generate new synthetic data based on the second prompt input 2730, and it may provide the output data 2740 including the new synthetic data to the client device.

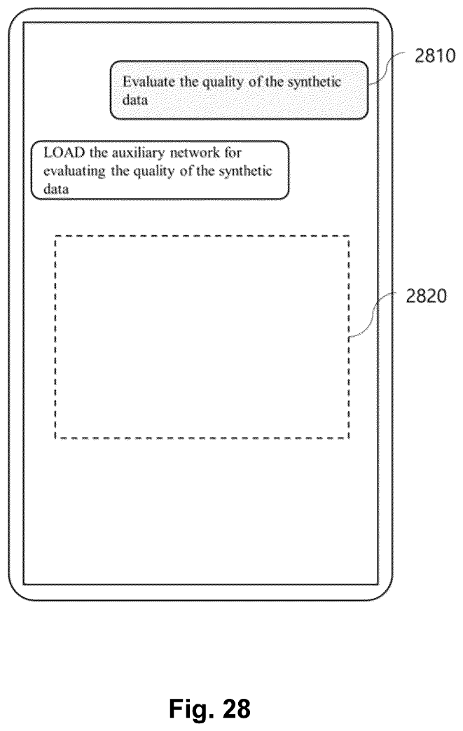

Referring to FIG. 28, the computing device may provide an interactive interface for evaluating the synthetic data using the auxiliary network. The processor may receive a first query 2810 requesting the evaluation of the data quality (e.g., “Evaluate the quality of the synthetic data”), and it may provide the output data 2820 including the quality evaluation information on the synthetic data to the client device based on the first query 2810. The processor may provide a response (e.g., “Load the auxiliary network for evaluating the quality of the synthetic data”) to the first query 2810 together with the output data 2820.

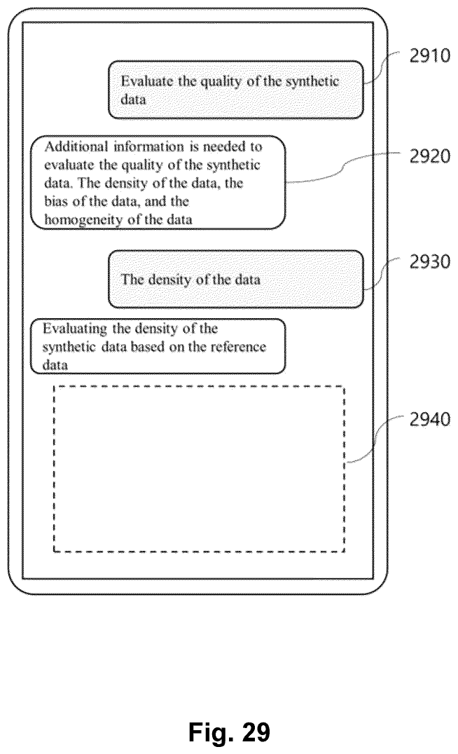

Referring to FIG. 29, the computing device may request additional information about data characteristic corresponding to the quality of the synthetic data. The processor may receive a first query 2910 requesting the evaluation of the data quality (e.g., “Evaluate the quality of the synthetic data”). The processor may provide the client device with a first response 2920 requesting additional information on the characteristic to be evaluated among multiple characteristics for synthetic data quality. For example, the first response may include text requesting the selection of specific characteristics among multiple characteristics (e.g., “Additional information is needed to evaluate the quality of the synthetic data. The density of the data, the bias of the data, and the homogeneity of the data”).

The processor may use reference data to evaluate the quality of the synthetic data. Specifically, the processor may evaluate the quality of the synthetic data based on the relationship between the synthetic data and the pre-stored reference data or the reference data provided from the client device.

When receiving the second query 2930 for the first response from the client device, the processor may provide the output data 2940 including the quality information about the synthetic data generated by calculating the characteristic indicated by the second query 2930. The processor may provide the second response (e.g., “Evaluating the density of the synthetic data based on the reference data”) for the second query 2930.

The methods described in various example embodiments may be implemented as program instructions performed by a computer or stored in a computer-readable medium. The computer-readable medium may include program instructions, data files, data structures, etc., alone or in combination. The program instructions stored in the medium may be designed and configured for the embodiments or may be known to those skilled in the art of computer software. Examples of the computer-readable medium include magnetic media such as hard disks, floppy disks, and magnetic tapes, optical media such as CD-ROMs, DVDs, magneto-optical media such as floptical disks, and hardware devices specially configured to store and perform program instructions such as ROMs, RAMs, and flash memories. Examples of the program instructions include not only machine codes such as those made by a compiler but also high-level language codes that may be executed by a computer using an interpreter, etc. The above-described hardware device may be configured to operate as one or more software modules to perform the operations of the embodiment, and vice versa.

Although the present disclosure is described with limited embodiments and drawings, various modifications and variations may be made by those skilled in the art. For example, appropriate results may be achieved even if the described techniques are performed in a different order or manner, and/or components such as the described system, structure, apparatus, and circuit are combined or substituted in a different form or replaced or substituted by other components or equivalents. Therefore, other implementations, other embodiments, and equivalents fall within the scope of the claims described below.

What is claimed is:

1. A computing device comprising:
a memory including at least one database; and
at least one processor electronically connected to the memory, wherein the at least one processor is configured to:
receive a first input query requesting data generation;
determine at least one constraint related to synthetic data based on the first input query;
obtain a first structured query processed in a predetermined manner suitable for a database based on the at least one constraint;
provide the first structured query to the database to obtain imported data by searching the database for data corresponding to the at least one constraint;
obtain a second structured query processed in a predetermined manner suitable for a generative model based on the at least one constraint;
provide the second structured query to the generative model;
obtain synthetic data from the generative model;
determine similarity between the imported data and the synthetic data by calculating a distance in embedding space between an embedded feature of the imported data and an embedded feature of synthetic data; and
provide output data comprising the imported data, the synthetic data, and similarity information reflecting the similarity between the imported data and the synthetic data,
wherein a query structure of the first structured query is different from a query structure of the second structured query.

2. The computing device of claim 1, wherein the first input query comprises a natural language query including at least one information about data to be generated.

3. The computing device of claim 1, wherein the at least one processor inputs the first input query to a natural language processing model (NLP) to determine the at least one constraint including an attribute of data to be generated.

4. The computing device of claim 3, wherein the at least one constraint comprises an attribute of the data to be generated and a sub-attribute of the attribute of the data.

5. The computing device of claim 4, wherein the number of the at least one constraint is determined based on information in the first input query.

6. The computing device of claim 1, wherein the at least one constraint is determined by understanding a user intention based on the first input query.

7. The computing device of claim 1, wherein the first structured query is a query for searching for data corresponding to the at least one constraint in the database.

8. The computing device of claim 1, wherein the at least one processor is further configured to perform an operation of obtaining first data corresponding to the at least one constraint based on the first structured query and the database, wherein the first data corresponds to a reference data stored in the database.

9. The computing device of claim 8, wherein the at least one processor is further configured to perform an operation of providing output data including the first data and the synthetic data.

10. The computing device of claim 1, wherein the second structured query comprises a prompt reflecting the at least one constraint.

11. The computing device of claim 1, wherein the at least one processor is further configured to perform:
an operation of receiving a first user input related to the synthetic data; and
an operation of storing the synthetic data in the database.

12. The computing device of claim 11, wherein the first user input comprises an approval input for the synthetic data.

13. The computing device of claim 1, wherein the at least one processor is further configured to:
receive a second user input related to the synthetic data;
obtain a third structured query by adjusting or regenerating the at least one constraint; and
obtain second synthetic data based on the third structured query and the generative model.

14. The computing device of claim 13, wherein the second user input comprises a user input indicating a modification to the synthetic data.

15. A method for generating data, comprising:
receiving, by at least one processor in a computing device, a first input query requesting data generation;
determining, based on the at least one constraint, at least one constraint related to synthetic data based on the first input query;
obtaining, based on the at least one constraint, a first structured query processed in a predetermined manner suitable for a database;
providing the first structured query to the database to obtain imported data by searching the database for data corresponding to the at least one constraint;
obtaining, based on the at least one constraint, a second structured query processed in a predetermined manner suitable for a generative model;
providing the second structured query to the generative model;
obtaining synthetic data from the generative model;
determining similarity between the imported data and the synthetic data by calculating a distance in embedding space between an embedded feature of the imported data and an embedded feature of synthetic data; and
providing output data comprising the imported data, the synthetic data, and similarity information reflecting the similarity between the imported data and the synthetic data,
wherein a query structure of the first structured query is different from a query structure of the second structured query.
